(19) United States
(12) Patent Application Publication
(10) Pub. No.: US 2008/0002160 A1
(43) Pub. Date: Jan. 3, 2008

(54) System and method for generating and displaying sub-frames with a multi-projector system

(76) Inventors: Nelson Liang An Chang, Palo Alto, CA (US); Niranjan Damera-Venkata, Palo Alto, CA (US); Simon Widdowson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/480,139

(22) Filed: Jun. 30, 2006

(51) Int. Cl. G03B 21/26

(52) U.S. Cl. 353/94

(57) ABSTRACT

A method of generating sub-frames for display by a multi-projector display system includes performing a geometric mapping of image boundaries of images projected by each of a plurality of projectors to a reference coordinate system. A global boundary is identified in the reference coordinate system that encompasses all of the image boundaries. A total display area of the multi-projector system is defined. A cropped display area is identified in the reference coordinate system that lies within the total display area. Sub-frames are generated for projection by the plurality of projectors based on the cropped display area.

### CROSS-REFERENCE TO RELATED APPLICATIONS

This application is related to U.S. patent application Ser. No. 11/080,223, filed Mar. 15, 2005, Attorney Docket No. 200500154-1, entitled “PROJECTION OF OVERLAPPING SINGLE-COLOR SUB-FRAMES ONTO A SURFACE”, and U.S. patent application Ser. No. 11/080,583, filed Mar. 15, 2005, Attorney Docket No. 200407867-1, entitled “PROJECTION OF OVERLAPPING SUB-FRAMES ONTO A SURFACE” which are hereby incorporated by reference herein.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed methods do not generate optimal sub-frames in real-time, and do not take into account arbitrary relative geometric distortion and luminance (brightness) variations between the component projectors. Multi-projector systems are typically set up manually without the aid of visual feedback, and these systems are not typically configured to provide visual feedback to assist a user in interactively adjusting display characteristics, such as aspect ratio, brightness, and resolution. In addition, these multi-projector systems are not typically configured to achieve an increased perceived resolution by combining tiled projectors and superimposed projectors in a hybrid configuration.

### SUMMARY

One form of the present invention provides a method of generating sub-frames for display by a multi-projector display system. The method includes performing a geometric mapping of image boundaries of images projected by each of a plurality of projectors to a reference coordinate system. The method includes identifying a global boundary in the reference coordinate system that encompasses all of the image boundaries. The method includes defining a total display area of the multi-projector system. The method includes identifying a cropped display area in the reference coordinate system that lies within the total display area. The method includes generating sub-frames for projection by the plurality of projectors based on the cropped display area.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a diagram illustrating a model of an image formation process according to one embodiment of the present invention.

FIG. 4 is a diagram illustrating the projection of a plurality of sub-frames onto a target surface according to one embodiment of the present invention.

FIG. 5 is a flow diagram illustrating a method for automatically analyzing a current configuration of the image display system shown in FIG. 1 and providing visual feedback according to one embodiment of the present invention.

FIG. 6 is a diagram illustrating two cropped display areas according to one embodiment of the present invention.

FIG. 7 is a flow diagram illustrating a method for providing visual feedback to assist a user in configuring the image display system shown in FIG. 1 according to one embodiment of the present invention.

FIG. 8 is a flow diagram illustrating a method for displaying images with a multi-projector display system according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,”

“front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

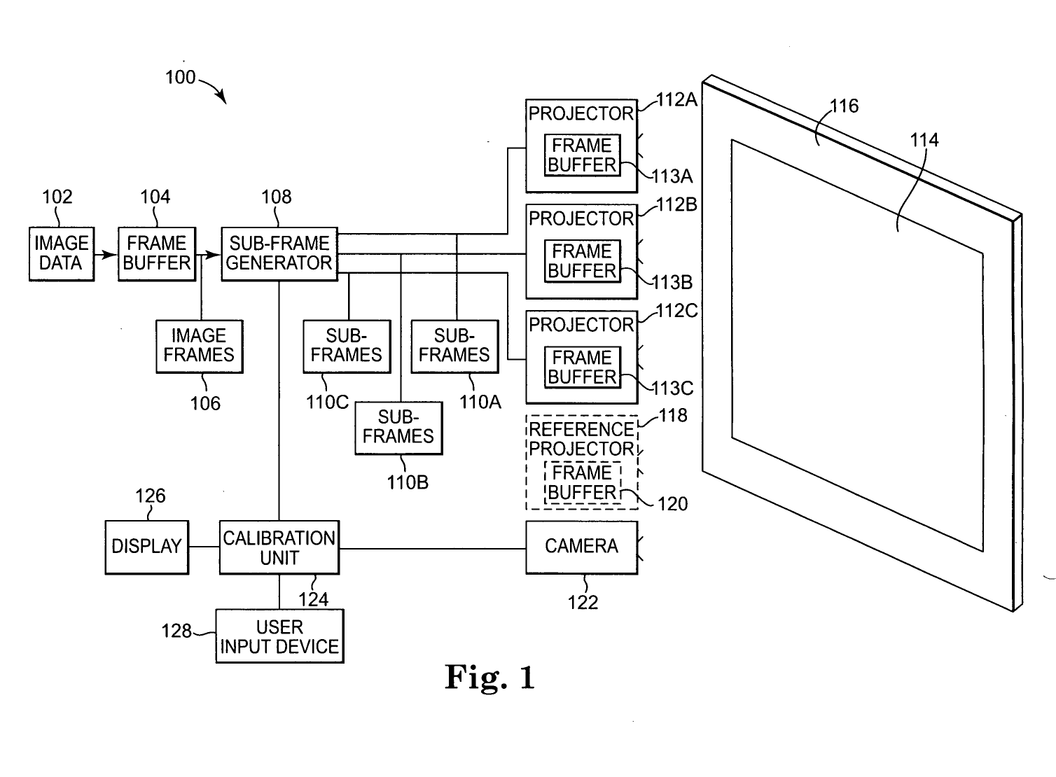

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generator 108, projectors 112A-112C (collectively referred to as projectors 112), camera 122, calibration unit 124, display 126, and user input device 128. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image-frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user. Target surface 116 can be planar or curved, or have any other shape. In one form of the invention, target surface 116 is translucent, and display system 100 is configured as a rear projection system. In an alternate embodiment, target surface 116 is a non-planar surface.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

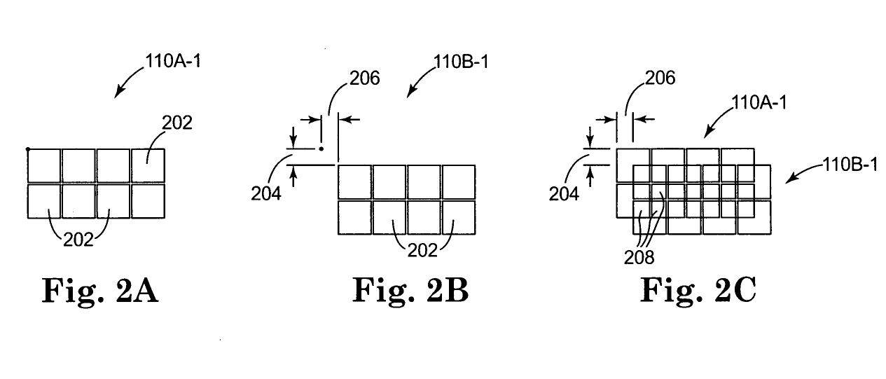

Projectors 112 receive image sub-frames 110 from sub-frame generator 108 and, in one embodiment, simultaneously project the image sub-frames 110 onto target surface 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves). It will be understood by persons of ordinary skill in the art that the sub-frames 110 projected onto target surface 116 may have perspective distortions, and the pixels may not appear as perfect squares with no variation in the offsets and overlaps from pixel to pixel, such as that shown in FIGS. 2A-2C. Rather, in one form of the invention, the pixels of sub-frames 110 take the form of distorted quadrilaterals or some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

A problem of sub-frame generation, which is addressed by embodiments of the present invention, is to determine appropriate values for the sub-frames 110 so that the displayed image 114 produced by the projected sub-frames 110 is close in appearance to how the high-resolution image (e.g., image frame 106) from which the sub-frames 110 were derived would appear if displayed directly.

It will be understood by a person of ordinary skill in the art that functions performed by sub-frame generator 108 may be implemented in hardware, software, firmware, or any combination thereof. In one embodiment, the implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

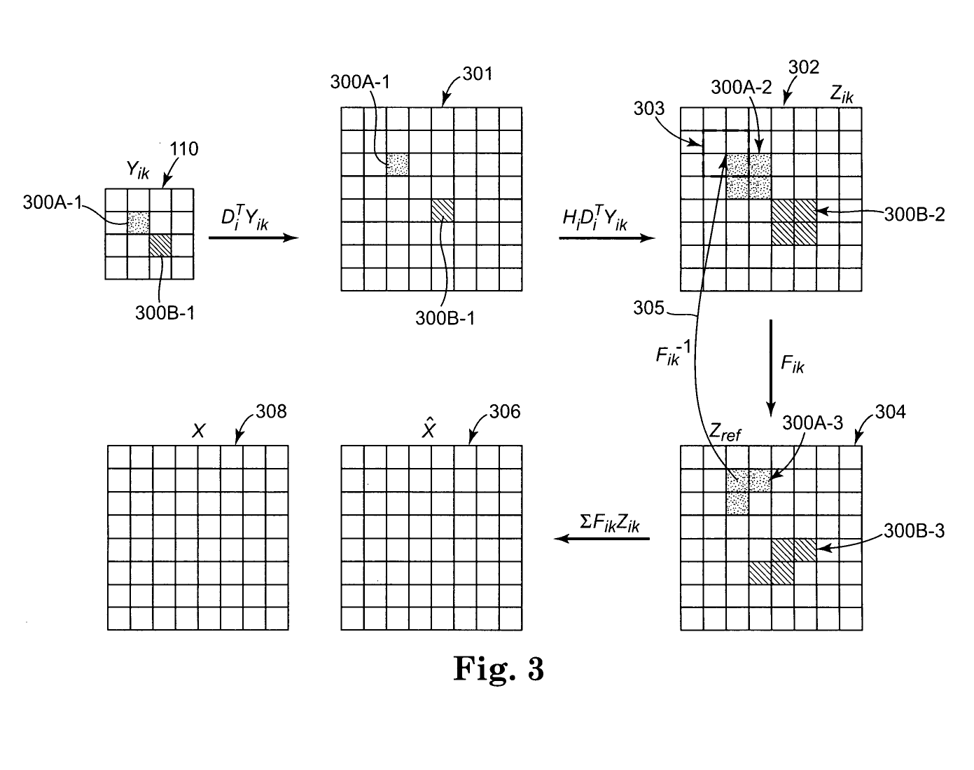

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIG. 3. In one embodiment, the location of one of the actual projectors 112 is defined to be the location of the reference projector 118.

In one embodiment, display system 100 includes a camera 122 and a calibration unit 124, which are used in one form of the invention to automatically determine a geometric mapping between each projector 112 and the reference projector 118, as described in further detail below with reference to FIG. 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environments.

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target surface 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B simultaneously projects second sub-frame 1110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution, brightness, and color of the displayed image 114.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel mis-registration to provide a displayed image 114 with a higher resolution than the individual sub-frames 110. In one embodiment, image formation due to multiple overlapped projectors 112 is modeled using a signal-processing model. Optimal sub-frames 110 for each of the component projectors 112 are estimated by sub-frame generator 108 based on the model, such that the resulting image predicted by the signal-processing model is as close as possible to the desired high-resolution image to be projected.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to FIG. 3.

FIG. 3 is a diagram illustrating a model of an image formation process according to one embodiment of the present invention. The sub-frames 110 are represented in the model by Yₖ, where “k” is an index for identifying the individual projectors 112. Thus, Y₁, for example, corresponds to a sub-frame 110A for a first projector 112A, Y₂ corresponds to a sub-frame 110B for a second projector 112B, etc. Two of the sixteen pixels of the sub-frame 110 shown in FIG. 3 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I
where:
   k=index for identifying the projectors 112;
   Zₖ=low-resolution sub-frame 110 of the kth projector 112 on a hypothetical high-resolution grid;
   Hₖ=Interpolating filter for low-resolution sub-frame 110 from kth projector 112;
   D^{T}=up-sampling matrix; and
   Yₖ=low-resolution sub-frame 110 of the kth projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 3, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the kth projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the kth projector 112 to a reference coordinate system, such as the frame buffer 120 of the reference projector 118 (FIG. 1), with sub-pixel accuracy, to generate a warped image 304 (Z_{ref}). In one embodiment, Fₖ is linear with respect to pixel intensities, but is non-linear with respect to the coordinate transformations. As shown in FIG. 3, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one form of the present invention, during the forward mapping (Fₖ), the inverse mapping (Fₖ⁻¹) is also utilized as indicated at 305 in FIG. 3. Each destination pixel in image 304 is back projected (i.e., Fₖ⁻¹) to find the corresponding location in image 302. For the embodiment shown in FIG. 3, the location in image 302 corresponding to the upper-left pixel of the pixels 300A-3 in image 304 is the location at the upper-left corner of the group of pixels 300A-2. In one form of the invention, the values for the pixels neighboring the identified location in image 302 are combined (e.g., averaged) to form the value for the corresponding pixel in image 304. Thus, for the example shown in FIG. 3, the value for the upper-left pixel in the group of pixels 300A-3 in image 304 is determined by averaging the values for the four pixels within the frame 303 in image 302.

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (X-hat) in the reference projector frame buffer 120, as represented in the following Equation II:

$$\hat{X} = {\sum }_{k} {F}_{k} {Z}_{k} \qquad Equation II$$

where:
   k=index for identifying the projectors 112;
   X-hat=hypothetical or simulated high-resolution image 306 in the reference projector frame buffer 120;
   Fₖ=operator that maps a low-resolution sub-frame 110 of the kth projector 112 on a hypothetical high-resolution grid to the reference projector frame buffer 120; and
   Zₖ=low-resolution sub-frame 110 of kth projector 112 on a hypothetical high-resolution grid, as defined in Equation I.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III
where:
   X=desired high-resolution frame 308;
   X-hat=hypothetical or simulated high-resolution frame 306 in the reference projector frame buffer 120; and
   η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation IV:

$${Y}_{k}^{*} = {argmax}_{{Y}_{k}} P ( \hat{X} \vert X ) \qquad Equation IV$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308; and
   P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
   X-hat=hypothetical or simulated high-resolution frame 306 in the reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{{‖ X - \hat{X} ‖}^{2}}{2 {σ}^{2}}} \qquad Equation VI$$

where:
   X-hat=hypothetical or simulated high-resolution frame 306 in the reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
   P(X-hat)=prior probability of X-hat;
   β=smoothing constant;
   Z(β)=normalization function;
   V=gradient operator; and
   X-hat=hypothetical or simulated high-resolution frame 306 in the reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {argmin}_{{Y}_{k}} {‖ X - \hat{X} ‖}^{2} + {β}^{2} {‖ ∇ \hat{X} ‖}^{2} \qquad Equation IX$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308;
   β=smoothing constant; and

∇=gradient operator.

The function minimization problem given in Equation IX is solved by substituting the definition of X-hat from Equation II into Equation 1× and taking the derivative with respect to Yₖ, which results in an iterative algorithm given by the following Equation X:

Yₖ⁽ⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘} Equation X
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ);
   X-hat⁽ⁿ⁾=hypothetical or simulated high-resolution frame 306 in the reference projector frame buffer 120, as defined in Equation II, for iteration number n;
   X=desired high-resolution frame 308;
   β=smoothing constant; and
   ∇²=Laplacian operator.

Equation X may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for the sub-frames 110 is determined. In one embodiment, the initial guess for the sub-frames 110 is determined by texture mapping the desired high-resolution frame 308 onto the sub-frames 110. In one form of the invention, the initial guess is determined from the following Equation XI:

Yₖ⁽⁰⁾=DBₖFₖ^{T}X Equation XI
where:
   k=index for identifying the projectors 112;
   Yₖ⁽⁰⁾=initial guess at the sub-frame data for the sub-frame 110 for the kth projector 112;
   D=down-sampling matrix;
   Bₖ=interpolation filter;
   Fₖ^{T}=Transpose of operator, Fₖ, from Equation II (in the image domain, Fₖ^{T} is the inverse of the warp denoted by Fₖ); and
   X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another form of the invention, the initial guess, Yₖ⁽⁰⁾, for the sub-frames 110 is determined from the following Equation XII

Yₖ⁽⁰⁾=DFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix;
   Fₖ^{T}=Transpose of operator, Fₖ, from Equation II (in the image domain, Fₖ^{T} is the inverse of the warp denoted by Fₖ); and
   X=desired high-resolution frame 308.

Equation XII is the same as Equation XI, except that the interpolation filter (Bₖ) is not used.

Several techniques are available to determine the geometric mapping (Fₖ) between each projector 112 and the reference projector 118, including manually establishing the mappings, or using camera 122 and calibration unit 124 (FIG. 1) to automatically determine the mappings. Techniques for determining geometric mappings that are suitable for use in one form of the present invention are described in U.S. patent application Ser. No. 10/356,858, filed Feb. 3, 2003, entitled “MULTIFRAME CORRESPONDENCE ESTIMATION”, and U.S. patent application Ser. No. 11/068,195, filed Feb. 28, 2005, entitled “MULTI-PROJECTOR GEOMETRIC CALIBRATION”, both of which are hereby incorporated by reference herein.

In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIII:

F₂=T₂T₁⁻¹ Equation XIII
where:
   F₂=operator that maps a low-resolution sub-frame 110 of the second projector 112B to the first (reference) projector 112A;
   T₁=geometric mapping between the first projector 112A and the camera 122; and
   T₂=geometric mapping between the second projector 112B and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

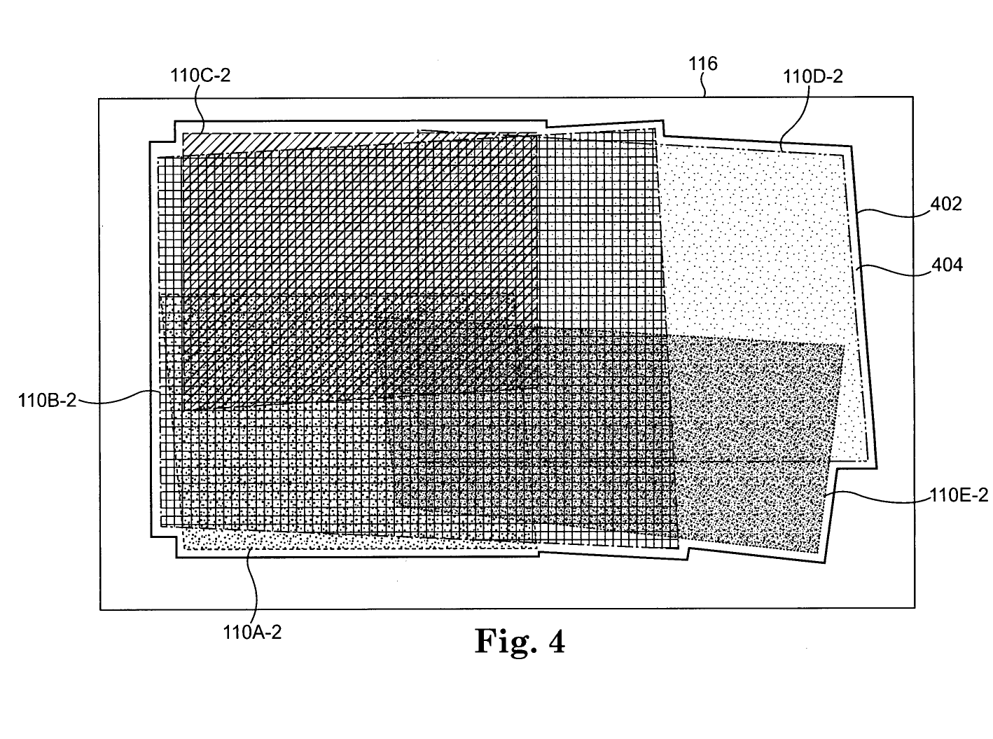

FIG. 4 is a diagram illustrating the projection of a plurality of sub-frames 110 onto target surface 116 according to one embodiment of the present invention. FIG. 4 shows sub-frames 110A-2, 110B-2, 110C-2, 110D-2, and 110E-2, which represents five sub-frames 110 projected onto target surface 116 by five different projectors 112. In the embodiment shown in FIG. 4, each of the sub-frames 110 has a quadrilateral shape, and the sub-frames 110 overlap each other in varying degrees. In one embodiment, the projected sub-frames 110 are all superimposed sub-frames. In another embodiment, the projected sub-frames 110 are all tiled sub-frames. In yet another embodiment, the projected sub-frames 110 include a combination of tiled and superimposed sub-frames (e.g., two tiled sub-frames 110, and two superimposed sub-frames 110 that substantially overlap each other and that each substantially overlap both of the tiled sub-frames 110).

In one form of the invention, two projected sub-frames 110 are defined to be tiled sub-frames if the area of any overlapping portion is less than about twenty percent of the total area of one of the projected sub-frames on the target surface 116, and two projected sub-frames are defined to be superimposed sub-frames if the area of the overlapping portion is eighty percent or more of the total area of one of the projected sub-frames on the target surface 116. In another form of the invention, where two or more sub-frames 110 overlap on target surface 116, regardless of the amount of overlap, the overlapping region may be regarded as superimposed, and the resolution of the projected image in the overlapping region can be enhanced by using the sub-frame generation algorithm described above with respect to Equation X. An arbitrary overlap can be regarded as a superimposition since, fundamentally, light is being superimposed. In a tiled region where there is no overlap, the light being superimposed from all except one projector 112 is close to zero. In one embodiment, sub-frames 110 are generated by sub-frame generator 108 for any arbitrary combination of tiled and superimposed projectors 112 based on techniques disclosed in U.S. patent application Ser. No. 11/301,060, filed on Dec. 12, 2005, and entitled SYSTEM AND METHOD FOR DISPLAYING AN IMAGE, which is hereby incorporated by reference herein.

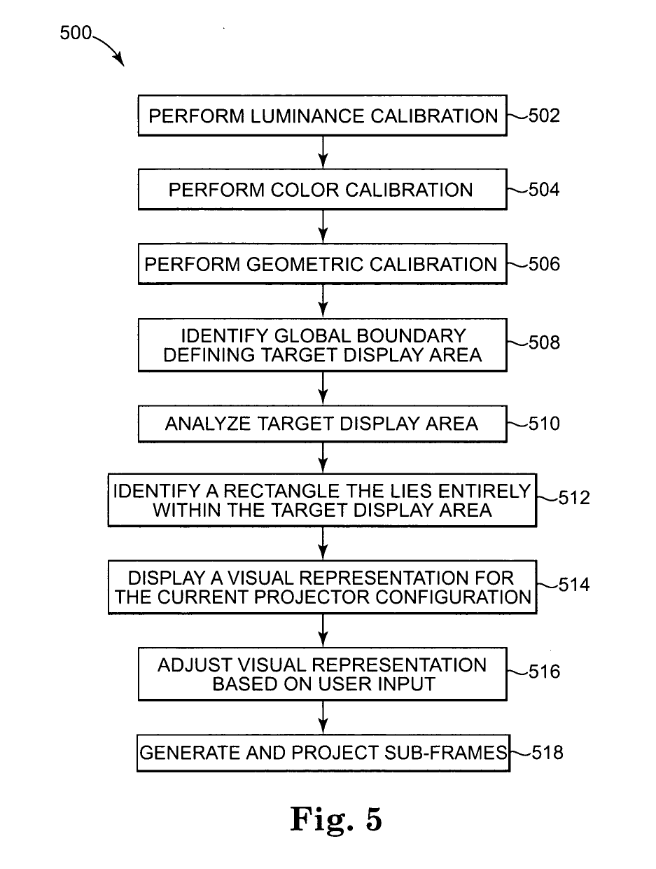

A global boundary 402 completely encompasses the five sub-frames 110 shown in FIG. 4. The global boundary 402 traces the portions of sub-frame edges located farthest away from the center of target surface 116. The area within the global boundary 402 is referred to herein as the target display area (or total display area) 404. The target display area 402 represents the total display area covered by all of the projectors 112 in the display system 100. Global boundary 402 and target display area 404 are described in further detail below with reference to FIGS. 5-8.

In one embodiment, images of the projected sub-frames 110A-2, 110B-2, 110C-2, 110D-2, and 110E-2 are captured by camera 122 (FIG. 1) and analyzed by calibration unit 124 (FIG. 1) to determine characteristics of the current projector configuration. In one form of the invention, calibration unit 124 is configured to display information (via display 126) regarding the current projector configuration, and allow a user to interactively adjust the display characteristics via user input device 128, as will be described in further detail below.

FIG. 5 is a flow diagram illustrating a method 500 for automatically analyzing a current configuration of the image display system 100 shown in FIG. 1 and providing visual feedback according to one embodiment of the present invention. Method 500 is described below with reference to the projected sub-frames 110 shown in FIG. 4.

At 502 in method 500, a luminance calibration is performed by calibration unit 124. In one embodiment, camera 122 is pre-calibrated using a spot photometer to characterize the flat field of camera 122 and account for any vignetting effects of camera 122. Following this, patterns of a solid grey value between 0 and 255 are projected at 502 by the projectors 112 and captured by the camera 122 to enable a mapping of the nonlinear gamma function of luminance as a function of pixel location and projector. In one embodiment, the luminance information determined at 502 is stored in a lookup table for faster processing.

In one embodiment, the luminance calibration at 502 is performed according to the techniques described in U.S. patent application Ser. No. 11/258,624, filed on Oct. 26, 2005, and entitled LUMINANCE BASED MULTIPLE PROJECTOR SYSTEM, which is hereby incorporated by reference herein. In other embodiments, other luminance calibration techniques may be used at 502.

At 504, a color calibration is performed by calibration unit 124. In one embodiment, a 3×3 color correaction transformation matrix is determined at 504 to map RGB color values of projectors 112 to corresponding values in a reference color space, such as CIE XYZ color space. One form of the present invention provides an accurate reproduction of color in the multi-projector display system 100. Given a desired high-resolution image 308 in CIE XYZ color space, sub-frame generator 108 determines the low-resolution sub-frames 110 that are to be projected from the component low-resolution projectors 112 so that the resulting image 114 is as close as possible to the original image 308 in CIE XYZ color space. In another embodiment, a linear color space other than CIE XYZ is used. The effects of different color characteristics of the individual projectors 112 are taken into account in the sub-frame generation process so that the color of the resulting image 114 accurately reproduces the color of the original high-resolution image 308. By taking into account color variations across multiple projectors 112, system 100 is able to provide consistent color reproduction. In one form of the invention, luminance and color variations are taken into account in the sub-frame generation process according to the techniques described in U.S. patent application Ser. No. 11/301,060, filed on Dec. 12, 2005, and entitled SYSTEM AND METHOD FOR DISPLAYING AN IMAGE, which is incorporated by reference.

At 506, calibration unit 124 performs a geometric calibration based on images of the projected sub-frames captured by camera 122. In this step, a geometric mapping is determined between each projector 112 and a reference coordinate system, such as the coordinate system of reference projector 118 (FIG. 1). In one embodiment, the geometric calibration at 506 is performed as described above with reference to FIG. 3, and Equations I, II, and XIII.

At 508, calibration unit 124 identifies a global boundary 402 (FIG. 4) in the reference coordinate system that encompasses all of the projected sub-frames 110. The global boundary 402 defines a target display area 404. In one embodiment, at 508, calibration unit 124 analyzes the geometric calibration information determined at 506 to calculate the global boundary 402. In one embodiment, the image boundaries (i.e., local boundaries) of the sub-frames 110 projected by each of the projectors 112 are analyzed by calibration unit 124, and a global boundary 402 is determined that includes each of the local boundaries of projected sub-frames 110.

At 510, calibration unit 124 analyzes the target display area 404, and determines the number of projectors 112 that are mapped to each pixel or region of the target display area 404. In one embodiment, the target display area 404 is assessed by calibration unit 124 at 510 for resolution, brightness, and sub-frame overlap, among other parameters. Based on the information obtained during the geometric calibration at 506, the amount of overlap and an approximate level of the resolution of the target display area 404 can be determined. In one embodiment, where two or more sub-frames 110 overlap on target surface 116, the resolution of the projected image in the overlapping region can be enhanced by using the sub-frame generation algorithm described above with respect to Equation X.

At 512, calibration unit 124 identifies at least one rectangle that lies entirely within the target display area 404. The area within the rectangle defines a cropped display area. In one form of the invention, the at least one rectangle is identified at 512 by geometrically mapping or warping the four corners of the field of view of each projector 112 to a reference coordinate system, such as the coordinate system of reference projector 118 (FIG. 1), and then determining an appropriate rectangle in the reference coordinate system based on the mapped corners. In one embodiment, the edges linking successive pairs of mapped corners are considered to be half-plane constraints (i.e., each edge may be viewed mathematically as a line separating points that lie inside the mapped field of view and points that lie outside the mapped field of view). The problem then becomes choosing the right set of constraint lines (half-spaces), and performing a linear program with constraints. For example, the optimal rectangle of a fixed aspect ratio is defined by two offset parameters (x0, y0) and a scale factor parameter (alpha). The linear program involves finding the values for these three parameters such that the entire rectangle lies on or inside of the appropriate half-spaces.

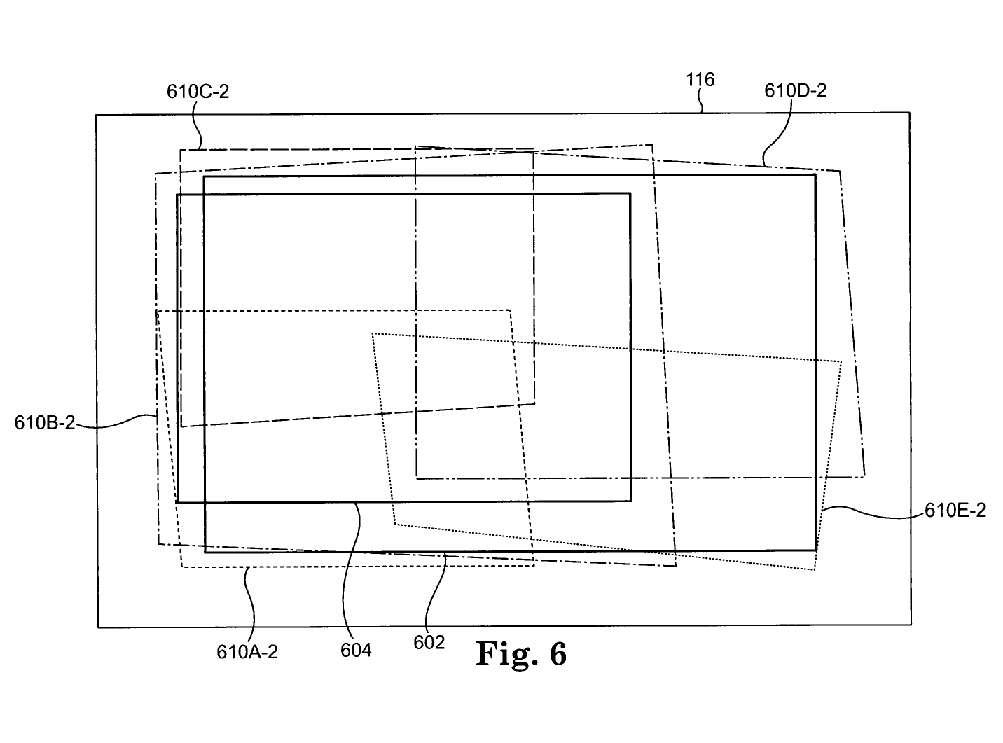

At 514, a visual representation for the current projector configuration is displayed. FIG. 6 shows one embodiment of the visual representation displayed at 514. As shown in FIG. 6, the visual representation includes image boundaries 610A-2 to 610E-2, which represent the boundaries of sub-frames 110A-2 to 110E-2 (FIG. 4), respectively. In one embodiment, the visual representation at 514 is projected by projectors 112 onto target surface 116. In another embodiment, the visual representation at 514 is displayed on display 126 based on images of projected sub-frames 110 captured by camera 122.

The visual representation shown in FIG. 6 also includes two cropped display areas 602 and 604, which correspond to rectangles identified at 512. In the illustrated embodiment, cropped display areas 602 and 604 represent the largest aspect ratio preserving rectangles that lie entirely within global boundary 402, and that correspond to a particular brightness level. In the illustrated embodiment, cropped display area 602 corresponds to a brightness parameter equal to “1”, and cropped display area 604 corresponds to a brightness parameter equal to “2”. A brightness parameter of “1” indicates that all points within the cropped display area are covered by at least one projector 112. A brightness parameter of “2” indicates that all points within the cropped display area are covered by at least two projectors 112. Typically, the higher the brightness parameter, the smaller the cropped display area will be. In one embodiment, the cropped display areas 602 and 604 are computed to have the same aspect ratio as that of the image data 102. In another embodiment, the cropped display area is the largest rectangular area that fits within the global boundary 402 regardless of aspect ratio.

In one embodiment, the visual representation displayed at 514 informs the user of the approximate display size, resolution, pixel density, and relative brightness for the current projector configuration. In one embodiment, the cropped display areas 602 and 604 are determined at 512 by calibration unit 124 based on user selection of specific image characteristics that are desired, such as display size, resolution, and brightness. For example, an image with the largest possible size may be desired, and as a result, a larger rectangle 604 would be chosen by calibration unit 124. In an alternate embodiment, an image with a higher brightness may be desired, and as a result, a smaller rectangle 602 would be chosen by calibration unit 124.

At 516 in method 500, the visual representation displayed at 514 is adjusted based on user input. In one embodiment, the user interactively manipulates the position and size of the cropped display area 602 or 604 via user input device 128 to achieve a desired combination of size, resolution, and brightness. In an alternate embodiment, the user can specify different kinds of cropping other than rectangular, such as circular, triangular, or some other shape.

At 518 in method 500, sub-frame generator 108 generates sub-frames 110 based on the current projector configuration and the cropped display area, and provides the sub-frames 110 to projectors 112 for projection. In one embodiment, when the aspect ratio has been modified at 516 by a user shrinking or stretching the cropped display area 602 or 604, the sub-frame generator 108 performs appropriate upsampling or downsampling to generate appropriate sub-frame data for the modified aspect ratio. In one embodiment, sub-frame generator 108 assigns a black value to any sub-frame pixel that will appear outside of the cropped display area 602 or 604.

In one embodiment, image display system 100 is a 3-D/stereoscopic-display system (via complementary polarized displays), where the projectors 112 are separated into two groups. An optimal cropped display area 602 or 604 is determined for each group by method 500 so that stereoscopic images can be displayed with the desired parameters.

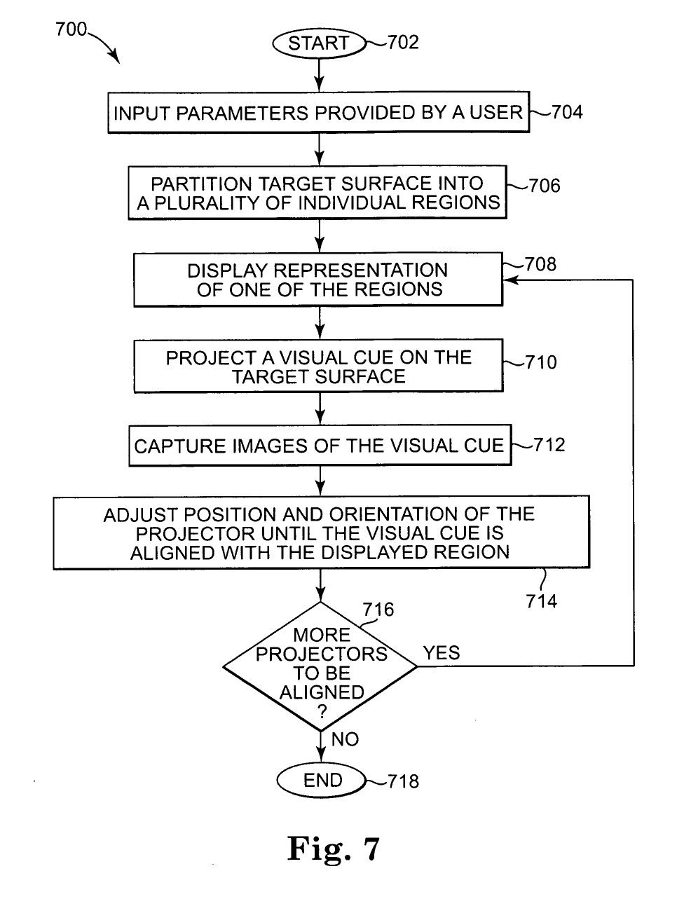

FIG. 7 is a flow diagram illustrating a method 700 for providing visual feedback to assist a user in configuring the image display system 100 shown in FIG. 1 according to one embodiment of the present invention. Method 700 begins at 702 and proceeds to 704, where input parameters are provided by a user to calibration unit 124. In one embodiment, the input parameters include desired image characteristics, such as display size, brightness, and resolution, as well as the total number of projectors 112, and specifications of the projectors 112. In another embodiment, the input parameters are automatically computed by calibration unit 124, or recommended by calibration unit 124 to the user.

At 706, calibration unit 124 partitions the target surface 116 into a plurality of individual regions based on the input parameters provided by a user at 704, and assigns each region to one of the projectors 112. In one embodiment, the regions identified at 706 are quadrilateral in shape.

At 708, calibration unit 124 displays a representation of one of the regions identified at 706 on display 126. At 710, one of the projectors 112 projects a visual cue on target surface 116. In one form of the invention, the visual cue projected at 710 is quadrilateral in shape. In one embodiment, the visual cue is a grid pattern. In another embodiment, the visual cue is a solid colored region.

At 712, camera 122 continually captures images of the visual cue displayed at 710. At 714, calibration unit 124 displays the images of the visual cue on display 126, such that the visual cue is overlaid on the display of the currently displayed region.

At 714, the position and orientation of the projector 112 that projected the visual cue at 710 is adjusted by a user until the visual cue displayed on display 126 is aligned with the displayed region.

At 716, calibration unit 124 determines whether there are any more projectors 112 in the system 100 remaining to be aligned. If it is determined at 716 that there are more projectors to be aligned, the method returns to step 708 to display the next one of the regions and align the next projector 112. If it is determined at 716 that there are no more projectors to be aligned, the method 700 moves to step 718, which indicates that the method 700 is done.

In one embodiment, method 700 sequentially goes through each projector 112A, 112B, 112C, and so on, and visual cues are projected by the projectors 112 to help the user position the projectors 112 to achieve the input parameters provided by the user. In one embodiment, the previous projector's visual cue is allowed to remain while the current projector's visual cue is being projected. Projection of visual cues provides context for the overall display by allowing the visualization of the intersection space of images from the projectors 112. For example, in an embodiment with two projectors 112, and where the visual cue is a solid colored region that varies in hue or saturation from projector to projector, if one projector 112A projects a visual cue in solid red, and a second projector 112B projects in solid blue, then the intersection region will appear in magenta.

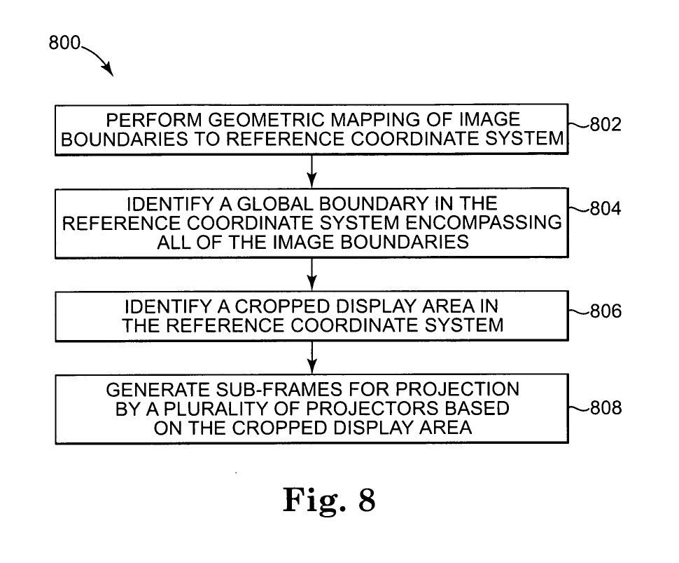

FIG. 8 is a flow diagram illustrating a method 800 of generating sub-frames for display by a multi-projector display system 100 (FIG. 1) according to one embodiment of the present invention. At 802, calibration unit 124 performs a geometric mapping of image boundaries of images projected by each of a plurality of projectors 112 to a reference coordinate system, such as the coordinate system of reference projector 118 (FIG. 1). In one embodiment, the geometric mapping at 802 is performed as described above with reference to FIG. 3, and Equations I, II, and XIII.

At 804, calibration unit 124 identifies a global boundary 402 (FIG. 4) in the reference coordinate system that encompasses all of the image boundaries and defines a total display area 404 of the multi-projector system 100. At 806, calibration unit 124 identifies a cropped display area 602 or 604 (FIG. 6) in the reference coordinate system that lies within the total display area 404.

At 808, sub-frame generator 108 generates sub-frames 110 for projection by the plurality of projectors 112 based on the cropped display area 602 or 604. It should be noted that, in one embodiment, the sub-frames 110 are generated at 808 according to the techniques shown in FIG. 3 and described above, where initial guesses for the sub-frames are determined from the high resolution image data 102 (see, e.g., Equations XI and XII and corresponding description). The sub-frames 110 are then generated from the initial guesses using an iterative process (see, e.g., Equation X and corresponding description) that is based on the model shown in FIG. 3 and described above. In one embodiment, sub-frame generator 108 assigns a common color value (e.g., black) to any sub-frame pixel that will appear outside of the cropped display area 602 or 604.

One form of the present invention provides an image display system 100 with multiple overlapped low-resolution projectors 112 coupled with an efficient real-time (e.g., video rates) image-processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution, brightness, and color, by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, in one embodiment of the present invention, there is no need for circuitry to offset the projected sub-frames 110 temporally. In one form of the invention, the sub-frames 110 from the component projectors 112 are projected “in-sync” (i.e., sub-frames 110 are simultaneously projected from multiple projectors 112 at the same time with no temporal offset between the projected sub-frames 110). As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal-processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

In one embodiment, image display system 100 is configured to project images 114 that have a three-dimensional (3D) appearance. In 3D image display systems, two different projectors simultaneously project two images, each with a different polarization. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of generating sub-frames for display by a multi-projector display system, the method comprising:
performing a geometric mapping of image boundaries of images projected by each of a plurality of projectors to a reference coordinate system;
identifying a global boundary in the reference coordinate system that encompasses all of the image boundaries and defines a total display area of the multi-projector system;
identifying a cropped display area in the reference coordinate system that lies within the total display area; and
generating sub-frames for projection by the plurality of projectors based on the cropped display area.

2. The method of claim 1, and further comprising:
determining a set of image characteristics associated with the total display area.

3. The method of claim 2, wherein the cropped display area is identified based on the determined set of image characteristics.

4. The method of claim 3, wherein the determined set of image characteristics includes at least one of brightness and resolution at various locations in the cropped display area.

5. The method of claim 3, wherein the cropped display area is identified based on the determined set of image characteristics and a set of desired characteristics specified by a user.

6. The method of claim 5, wherein the desired characteristics include at least one of display size, resolution, and brightness.

7. The method of claim 1, and further comprising:
displaying the image boundaries and a boundary of the cropped display area.

8. The method of claim 7, wherein the boundary of the cropped display area is interactively adjustable by a user.

9. The method of claim 1, and further comprising:
performing a luminance calibration and a color calibration for each of the plurality of projectors.

10. The method of claim 1, wherein pixels of the generated sub-frames that will appear outside of the cropped display area when projected are assigned a common color value.

11. The method of claim 1, wherein the reference coordinate system corresponds to a hypothetical reference projector.

12. The method of claim 1, wherein the projected sub-frames from the plurality of projectors are tiled sub-frames.

13. The method of claim 1, wherein the projected sub-frames from the plurality of projectors are superimposed sub-frames.

14. The method of claim 1, wherein the projected sub-frames from the plurality of projectors include a combination of tiled and superimposed sub-frames.

15. A multi-projector display system comprising:
a first projector adapted to project a first sub-frame onto a target surface;
a second projector adapted to project a second sub-frame onto the target surface;
a camera configured to capture at least one image of the first and second sub-frames; and
a controller configured to analyze the at least one image and determine a cropped display area.

16. A method of aligning projectors of a multi-projector display system, the method comprising:
receiving input parameters from a user;
identifying a plurality of regions of a display surface based on the input parameters;
assigning one of the regions to each projector in the display system;
displaying an image identifying a first one of the regions;
projecting a visual cue with a first one of the projectors; and
adjusting a position of the first projector to align the visual cue with the displayed first region.

17. The method of claim 16, wherein the input parameters include at least one of display size, brightness, and resolution.

18. The method of claim 16, wherein the regions and the visual cue have quadrilateral shapes.

19. The method of claim 16, wherein the visual cue is one of a grid pattern or a solid colored area.

20. The method of claim 16, and further comprising:
displaying an image identifying a second one of the regions;
projecting a visual cue with a second one of the projectors; and
adjusting a position of the second projector to align the visual cue with the displayed second region.
